(19) United States
(12) Patent Application Publication
(10) Pub. No.: US 2024/0121359 A1
(43) Pub. Date: Apr. 11, 2024

(54) TERMINAL APPARATUS

(71) Applicant: TOYOTA JIDOSHA KABUSHIKI KAISHA, Aichi-ken (JP)

(72) Inventors: Wataru KAKU, Tokyo-to (JP); Tatsuro HORI, Tokyo-to (JP); Jorge PELAEZ, Kawaguchi-shi (JP)

(21) Appl. No.: 18/481,233

(22) Filed: Oct. 5, 2023

(30) Foreign Application Priority Data
Oct. 7, 2022 (JP) 2022-162659

(51) Int. Cl. H04N 7/15; G06F 3/041; G06V 40/10; G06V 40/20

(52) U.S. Cl. CPC H04N 7/157; G06F 3/0412; G06V 40/11; G06V 40/28

(57) ABSTRACT

A terminal apparatus includes a communication interface, a transparent panel configured to display an image and accept a drawing, a display superimposed on the transparent panel, an imager disposed near the display and configured to capture an image of a user, and a controller configured to communicate using the communication interface. The controller is configured to receive, from another terminal apparatus, information for displaying a model image representing another user who uses the other terminal apparatus based on a captured image of the other user, and information on a drawn image drawn by the other user using a drawing tool on a transparent panel of the other terminal apparatus, and to display the model image on the display of the terminal apparatus and a hand image of a hand of the other user holding the drawing tool and the drawn image on the transparent panel of the terminal apparatus.

### CROSS-REFERENCE TO RELATED APPLICATION

This application claims priority to Japanese Patent Application No. 2022-162659, filed on Oct. 7, 2022, the entire contents of which are incorporated herein by reference.

### TECHNICAL FIELD

The present disclosure relates to a terminal apparatus.

### BACKGROUND

An apparatus that displays images and the like on a transparent touch panel and outputs various information to a user while accepting input of various types of information is known. Technology has been proposed to use such apparatuses as videophone terminals that enable video calls over a network. For example, Patent Literature (PTL) 1 discloses a videophone apparatus that projects video light onto a large hologram screen to project full-color or monochrome video or still images while also functioning as an information terminal.

### CITATION LIST

### Patent Literature

PTL 1: JP 2003-005617 A

### SUMMARY

There is room for improvement in the realistic feel of communication in technology in which users communicate with each other by exchanging captured images, drawings, and the like using a terminal apparatus that has a transparent touch panel.

The present disclosure provides a terminal apparatus and the like that can enhance the realistic feel of communication using a transparent touch panel.

A terminal apparatus in the present disclosure is a terminal apparatus including:
a communication interface;
a transparent panel configured to display an image and accept a drawing;
a display superimposed on the transparent panel;
an imager disposed near the display and configured to capture an image of a user; and
a controller configured to communicate using the communication interface, wherein
the controller is configured to receive, from another terminal apparatus, information for displaying a model image representing another user who uses the another terminal apparatus based on a captured image of the another user, and information on a drawn image that is drawn by the another user using a drawing tool on a transparent panel of the another terminal apparatus, and to display the model image on the display of the terminal apparatus and a hand image of a hand of the another user holding the drawing tool and the drawn image on the transparent panel of the terminal apparatus.

According to the terminal apparatus and the like in the present disclosure, the realistic feel of communication using a transparent panel can be enhanced.

### BRIEF DESCRIPTION OF THE DRAWINGS

In the accompanying drawings:

FIG. 1 is a diagram illustrating a configuration example of a call system;

FIG. 2 is a diagram illustrating a user using a terminal apparatus;

FIG. 3A is a diagram illustrating an example of display by the terminal apparatus;

FIG. 3B is a diagram illustrating an example of display by the terminal apparatus;

FIG. 4 is a sequence diagram illustrating an operation example of the call system;

FIG. 5A is a flowchart illustrating an example of operations of the terminal apparatus;

FIG. 5B is a flowchart illustrating an example of operations of the terminal apparatus;

FIG. 6A is a diagram illustrating an example of display by the terminal apparatus; and

FIG. 6B is a diagram illustrating an example of display by the terminal apparatus.

### DETAILED DESCRIPTION

Embodiments are described below.

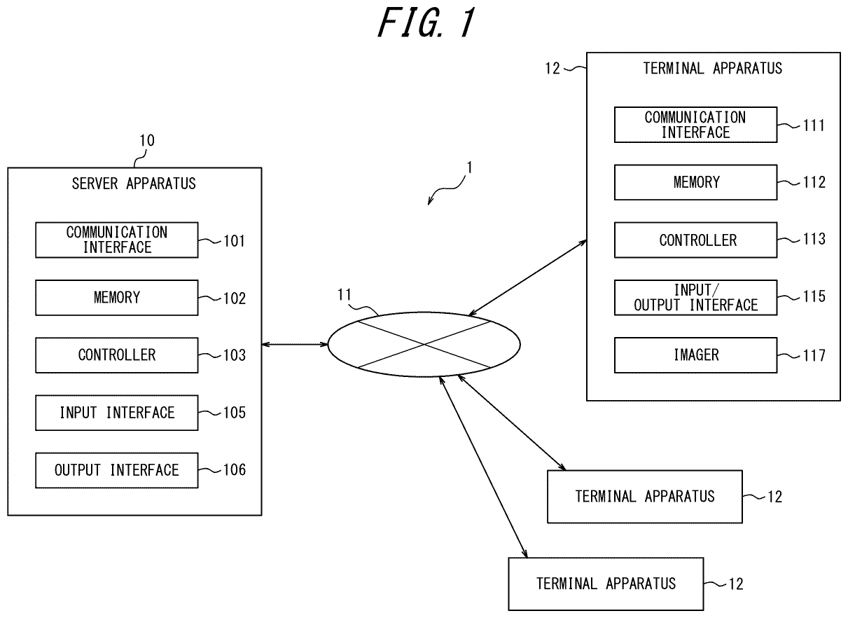

FIG. 1 is a diagram illustrating an example configuration of a call system 1 in an embodiment. The call system 1 includes a plurality of terminal apparatuses 12 and a server apparatus 10 that are connected via a network 11 to enable communication of information with each other. The call system 1 is a system to enable users to perform virtual face-to-face communication with each other by transmitting and receiving images, voice, and the like using the terminal apparatuses 12 (hereinafter referred to as “virtual face-to-face communication”).

The server apparatus 10 is, for example, a server computer that belongs to a cloud computing system or other computing system and functions as a server that implements various functions. The server apparatus 10 may be configured by two or more server computers that are communicably connected to each other and operate in cooperation. The server apparatus 10 transmits and receives, and performs information processing on, information necessary to provide virtual face-to-face communication.

The terminal apparatus 12 is an information processing apparatus provided with communication functions and input/output functions for images, audio, and the like and is used by a user. The terminal apparatus 12 includes an information processing apparatus, provided with a communication function and a function to display images and the like, and a transparent touch panel. The terminal apparatus 12 may be an apparatus dedicated to virtual face-to-face communication or may, for example, be configured by a combination of a smartphone, tablet terminal, personal computer, digital signage, or the like and a transparent touch panel.

The network 11 may, for example, be the Internet or may include an ad hoc network, a local area network (LAN), a metropolitan area network (MAN), other networks, or any combination thereof.

In the present embodiment, the terminal apparatus 12 receives, from another terminal apparatus 12, information for displaying a model image representing another user who uses the other terminal apparatus 12 based on a captured image of the other user, and information on a drawn image that is drawn by the other user using a drawing tool on a transparent touch panel of the other terminal apparatus 12, and displays the model image on its own display and a hand image of a hand holding the drawing tool and the drawn image on its own transparent touch panel. Even in a case in which the hand of the other user holding the drawing tool does not appear in the captured image due to the position and angle of view of the imager capturing the image, the hand image can be supplemented to enhance the realistic feel of the displayed model image.

Respective configurations of the server apparatus 10 and the terminal apparatuses 12 are described in detail.

The server apparatus 10 includes a communication interface 101, a memory 102, a controller 103, an input interface 105, and an output interface 106. These configurations are appropriately arranged on two or more computers in a case in which the server apparatus 10 is configured by two or more server computers.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the terminal apparatuses 12 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The input interface 105 includes one or more interfaces for input. The interface for input is, for example, a physical key, a capacitive key, a pointing device, a touch panel integrally provided with a display, or a microphone that receives audio input. The input interface 105 accepts operations to input information used for operation of the server apparatus 10 and transmits the inputted information to the controller 103.

The output interface 106 includes one or more interfaces for output. The interface for output is, for example, a display or a speaker. The display is, for example, a Liquid Crystal Display (LCD) or an organic Electro Luminescent (EL) display. The output interface 106 outputs information obtained by the operations of the server apparatus 10.

The functions of the server apparatus 10 are realized by a processor included in the controller 103 executing a control program. The control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

Each terminal apparatus 12 includes a communication interface 111, a memory 112, a controller 113, an input/output interface 115, and an imager 117.

The communication interface 111 includes a communication module compliant with a wired or wireless LAN standard, a module compliant with a mobile communication standard such as LTE, 4G, or 5G, or the like. The terminal apparatus 12 connects to the network 11 via a nearby router apparatus or mobile communication base station using the communication interface 111 and communicates information with the server apparatus 10 and the like over the network 11.

The memory 112 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 112 functions as, for example, a main memory, an auxiliary memory, or a cache memory. The memory 112 stores information to be used for the operations of the controller 113 and information obtained by the operations of the controller 113.

The controller 113 has one or more general purpose processors, such as CPUs or Micro Processing Units (MPUs), or one or more dedicated processors, such as GPUs, that are dedicated to specific processing. Alternatively, the controller 113 may have one or more dedicated circuits such as FPGAs or ASICs. The controller 113 is configured to perform overall control of the operations of the terminal apparatus 12 by operating according to the control/processing programs or operating according to operating procedures implemented in the form of circuits. The controller 113 then transmits and receives various types of information to and from the server apparatus 10 and the like via the communication interface 111 and executes the operations according to the present embodiment.

The functions of the controller 113 are realized by a processor included in the controller 113 executing a control program. The control program is a program for causing the processor to function as the controller 113. Some or all of the functions of the controller 113 may be realized by a dedicated circuit included in the controller 113. The control program may be stored on a non-transitory recording/storage medium readable by the terminal apparatus 12 and be read from the medium by the terminal apparatus 12.

The input/output interface 115 includes a transparent touch panel, a display, and one or more interfaces for input and output. The input/output interface 115 detects the input of drawn images based on the displacement of the contact position of a finger, pointing device, or the like on the transparent touch panel and transmits the detected information to the controller 113. The transparent touch panel is configured to include a transparent display and displays information, such as images transmitted from the controller 113 and images corresponding to contact by a pointing device or the like. The display is, for example, an LCD or organic EL display and displays information such as images transmitted from the controller 113. The interface for input includes, for example, a physical key, a capacitive key, or a pointing device. The interface for input may also include a microphone that accepts audio input. The interface for input may further include a scanner, camera, or IC card reader that scans an image code. The interface for output includes, for example, a speaker. The input/output interface 115 accepts operations for inputting information to be used in the operations of the controller 113, transmits the inputted information to the controller 113, or outputs information obtained by operation of the controller 113.

The imager 117 includes a camera that captures an image of a subject using visible light and a distance measuring sensor that measures the distance to the subject to acquire a distance image. The camera captures a subject at, for example, 15 to 30 frames per second to produce a moving image formed by a series of captured images. Distance measurement sensors include ToF (Time Of Flight) cameras, LiDAR (Light Detection And Ranging), and stereo cameras and generate distance images of a subject that contain distance information. The imager 117 transmits the captured images and the distance images to the controller 113.

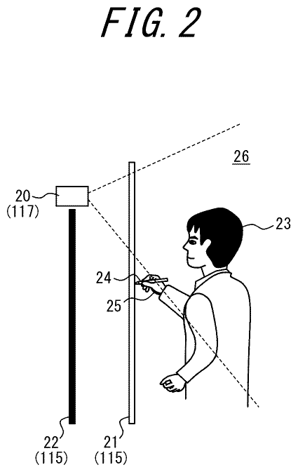

FIG. 2 illustrates an example of the arrangement of the transparent touch panel, the display, and the camera of the imager 117 in the input/output interface 115. The transparent touch panel 21 is located between the display 22 and a user 23. The user 23 can view a model image of another user displayed on the display 22 by looking through the transparent touch panel 21 and draws an image on the transparent touch panel 21 using a drawing tool 24. By the display 22 being provided on the other side of the transparent touch panel 21 from the user 23, and the model image of the other user being display there, the realistic feel of the user experience can be enhanced, as if the user were communicating with the other user via the transparent touch panel 21 while drawing. Such a configuration can foster a more realistic feel with depth as compared, for example, to the case of displaying the model image of another user on the transparent touch panel 21. The camera 20 is located near, such as above, the display 22. If the camera 20 is provided at a position superimposed on the display 22, there is a risk that the camera 20 will block the image displayed on the display 22, or that the drawn image that is drawn on the transparent touch panel 21 will block the capture of an image of the user 23 by the camera 20. In this regard, by the camera 20 being provided above the display 22, an image of the user 23 can be captured through the transparent touch panel 21, without interruption of image display or image capture.

In the terminal apparatus 12 configured as described above, the controller 113 acquires a captured image and a distance image of the user 23 via the imager 117. The controller 113 also collects the audio of speech by the user 23 with the microphone in the input/output interface 115. Furthermore, from the input/output interface 115, the controller 113 acquires information on the drawn image that the user 23 draws on the transparent touch panel 21 of the input/output interface 115. The controller 113 encodes the captured image and distance image of the user 23, which are for generating the model image of the user 23, the drawn image that is drawn by the user 23, and audio information, which is for reproducing the speech of the user 23, to generate encoded information. The model image can, for example, be a 3D model, a 2D model, or the like, but a 3D model is used below as an example. The controller 113 may perform any appropriate processing (such as resolution change or trimming) on the captured images and the like at the time of encoding. Here, since the camera 20 is located above the display 22, a hand 25 of the user 23 holding the drawing tool 24 might not be included in an angle range 26 of the camera 20. Therefore, the controller 113 omits the hand 25 from the 3D model. The controller 113 also derives the position of the drawn image relative to the user 23 based on the captured image of the user 23. For example, the position of the drawn image relative to the user 23 is derived based on the positional relationship between the camera 20 and the transparent touch panel 21, the position of the user 23 relative to the camera 20, and the position of the drawn image on the transparent touch panel 21. The controller 113 then determines the position at which to display the drawn image relative to the 3D model of the user 23 so as to correspond to the derived position. Such position information is also included in the encoded information. The controller 113 uses the communication interface 111 to transmit the encoded information to the other terminal apparatus 12 via the server apparatus 10.

The controller 113 also receives encoded information, transmitted from the other terminal apparatus 12 via the server apparatus 10, using the communication interface 111. Upon decoding the encoded information received from the other terminal apparatus 12, the controller 113 uses the decoded information to generate a 3D model representing the other user who uses the other terminal apparatus 12. In generating the 3D model, the controller 113 generates a polygon model using the distance images of the other user and applies texture mapping to the polygon model using the captured images of the other user, thereby generating the 3D model of the other user. This example is not limiting, however, and any appropriate method can be used to generate the 3D model. The controller 113 generates a rendered image, from a virtual viewpoint, of the virtual space containing the 3D model. The virtual viewpoint is, for example, the position of the eyes of the user 23. The controller 113 derives the spatial coordinates of the eyes with respect to a freely chosen reference from the captured image of the user 23 and maps the result to spatial coordinates in the virtual space. The freely chosen reference is, for example, the position of the camera 20. The 3D model of the other user is placed at a position and angle that, for example, enable eye contact with the virtual viewpoint. At this time, the model of the other user's hand 25 is omitted. The controller 113 displays the rendered image on the display 22 and displays a hand image of the hand holding the drawing tool and the drawn image on the transparent touch panel 21. The hand image is an image of the hand holding the drawing tool, including an image of the drawing tool, and is stored in the memory 112 in advance. The controller 113 uses the input/output interface 115 to display images for display and output speech of the other user based on the other user's audio information.

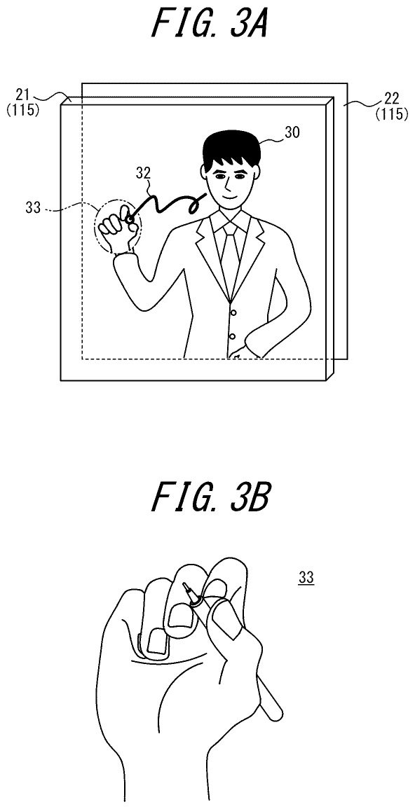

FIG. 3A illustrates an example of a 3D model of the other user being displayed. A 3D model 30 of the other user is displayed on the display 22 located behind the transparent touch panel 21. On the other hand, a hand image 33 and a drawn image 32 are displayed on the transparent touch panel 21. As illustrated in the enlargement in FIG. 3B, the hand image 33 is an image depicting the drawing tool and a portion of the hand holding the tool from the wrist up, as observed from the tip of the drawing tool or the palm of the hand. By the hand image 33 and the drawn image 32 being displayed on the transparent touch panel 21 in the foreground, the 3D model 30 of the other user is provided an additional three-dimensional effect. The realistic feel of the displayed 3D model can thereby be enhanced.

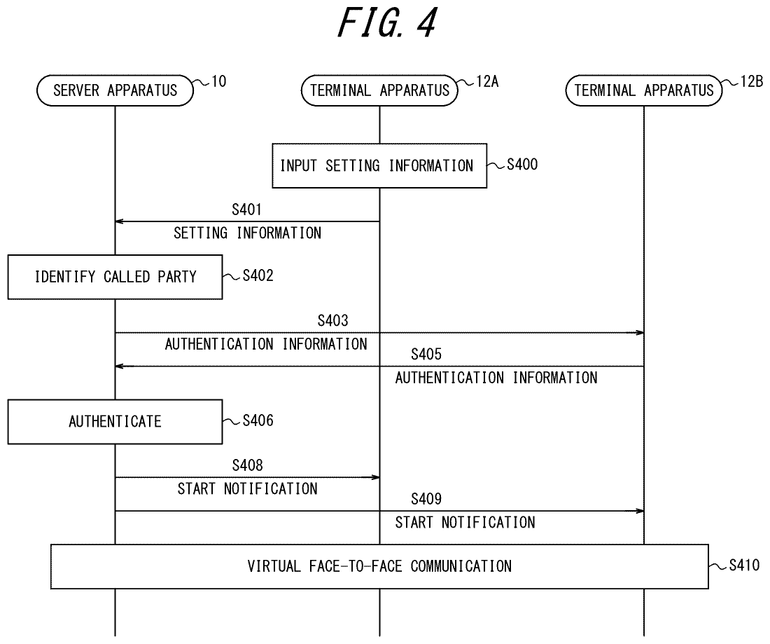

FIG. 4 is a sequence diagram illustrating the operating procedures of the call system 1. This sequence diagram illustrates the steps in the coordinated operation of the server apparatus 10 and the plurality of terminal apparatuses 12 (referred to for the sake of convenience as the terminal apparatus 12A and 12B when distinguishing therebetween). These steps are for the terminal apparatus 12A to call the terminal apparatus 12B. In a case of a plurality of terminal apparatuses 12B being called, the operating procedures for the terminal apparatus 12B illustrated here are performed by each terminal apparatus 12B, or by each terminal apparatus 12B and the server apparatus 10.

The steps pertaining to the various information processing by the server apparatus 10 and the terminal apparatuses 12 in FIG. 4 are performed by the respective controllers 103 and 113. The steps pertaining to transmitting and receiving various types of information to and from the server apparatus 10 and the terminal apparatuses 12 are performed by the respective controllers 103 and 113 transmitting and receiving information to and from each other via the respective communication interfaces 101 and 111. In the server apparatus 10 and the terminal apparatuses 12, the respective controllers 103 and 113 appropriately store the information that is transmitted and received in the respective memories 102 and 112. Furthermore, the controller 113 of the terminal apparatus 12 accepts input of various types of information with the input/output interface 115 and outputs various types of information with the input/output interface 115.

In step S400, the terminal apparatus 12A accepts input of setting information by the corresponding user. The setting information includes a call schedule, a list of called parties, and the like. The list includes the username of the called party and each user's email address. In step S401, the terminal apparatus 12A then transmits the setting information to the server apparatus 10. The server apparatus 10 receives the information transmitted from the terminal apparatus 12A. For example, the terminal apparatus 12A acquires an input screen for setting information from the server apparatus 10 and displays the input screen to the user. Then, once the user inputs the setting information on the input screen, the setting information is transmitted to the server apparatus 10.

In step S402, the server apparatus 10 identifies the called party based on the setting information. The controller 103 stores the setting information and information on the called party in association in the memory 102.

In step S403, the server apparatus 10 transmits authentication information to the terminal apparatus 12B. The authentication information is information such as an ID or passcode for identifying and authenticating the called party who uses the terminal apparatus 12B. Such information is, for example, transmitted as an e-mail attachment. The terminal apparatus 12B receives the information transmitted from the server apparatus 10.

In step S405, the terminal apparatus 12B transmits the authentication information received from the server apparatus 10 and information on an authentication application to the server apparatus 10. The called party operates the terminal apparatus 12B and applies for authentication using the authentication information transmitted by the server apparatus 10. For example, the terminal apparatus 12B accesses a site provided by the server apparatus 10 for the call, acquires the input screen for the authentication information and the information on the authentication application, and displays the input screen to the called party. The terminal apparatus 12B then accepts the information inputted by the called party and transmits the information to the server apparatus 10.

In step S406, the server apparatus 10 performs authentication on the called party. The identification information for the terminal apparatus 12B and the identification information for the called party are stored in association in the memory 102.

In steps S408 and S409, the server apparatus 10 transmits a call start notification to the terminal apparatuses 12A and 12B. Upon receiving the information transmitted from the server apparatus 10, the terminal apparatuses 12A and 12B begin the imaging and collection of audio of speech for the respective users.

In step S410, virtual face-to-face communication including a call between users is performed by the terminal apparatuses 12A and 12B via the server apparatus 10. The terminal apparatuses 12A and 12B transmit and receive information for displaying 3D models representing the respective users, the drawn images, and information on speech to each other via the server apparatus 10. The terminal apparatuses 12A and 12B output images, including the 3D model representing the other user, and speech of the other user to the respective users.

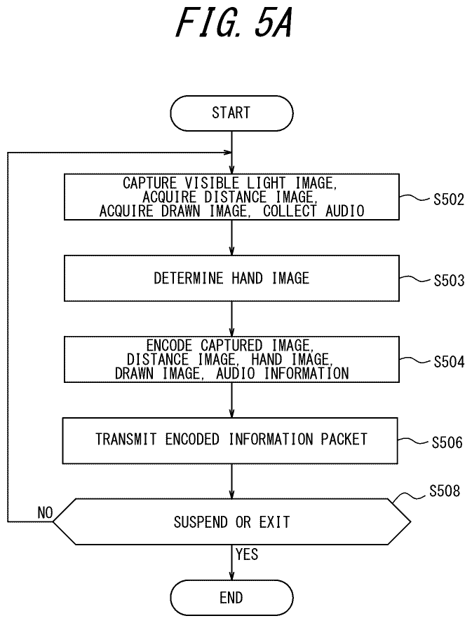

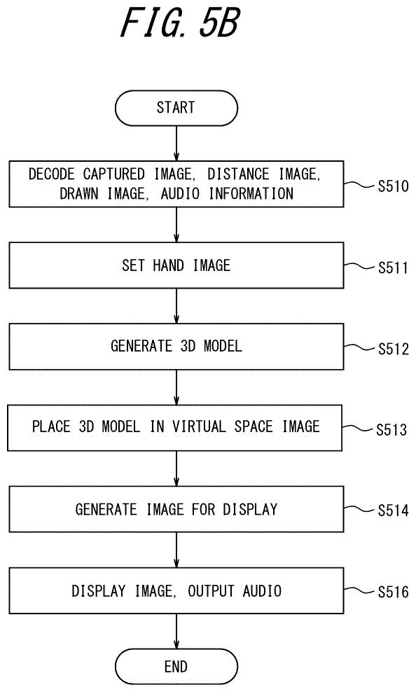

FIGS. 5A and 5B are flowcharts illustrating the operating procedures of the terminal apparatus 12 for performing virtual face-to-face communication. The procedures illustrated here are common to the terminal apparatuses 12A and 12B and are described without distinguishing between the terminal apparatuses 12A and 12B.

FIG. 5A relates to the operating procedures of the controller 113 when each terminal apparatus 12 transmits information for displaying a 3D model of the user who uses that terminal apparatus 12.

In step S502, the controller 113 acquires a visible light image and a distance image, acquires the drawn image, and collects sound. The controller 113 uses the imager 117 to capture the visible light image of the corresponding user and the distance image at a freely set frame rate. The controller 113 also acquires the drawn image via the input/output interface 115. Furthermore, the controller 113 collects sound of the corresponding user's speech via the input/output interface 115.

In step S503, the controller 113 determines the hand image. The controller 113 performs any appropriate image processing, including pattern matching, on the captured image to estimate attributes of the corresponding user. The attributes are the dominant hand, gender, age, and the like. The dominant hand, i.e., the hand holding the drawing tool, is a distinction between left and right. The memory 112 stores hand images of the left and right hands in advance. The hand images include hand images for each gender or age group. Such hand images are created in advance based on hand images of models of different genders or age groups. The controller 113 selects and determines the hand image corresponding to the estimated attributes. Alternatively, the controller 113 may extract the hand image from previous captured images. An image of the hand holding the drawing tool might be included in the captured image during the drawing operation by the user, as a result of the drawing tool and the part of the hand holding the drawing tool being included in the angle range of the camera 20. The controller 113 may detect such a captured image and extract the hand image from the captured image.

In step S504, the controller 113 encodes the captured image, the distance image, the hand image, the drawn image, and the audio information to generate encoded information.

In step S506, the controller 113 converts the encoded information into packets using the communication interface 111 and transmits the packets to the server apparatus 10 for the other terminal apparatus 12.

When information inputted for an operation by the corresponding user to suspend imaging and collection of audio or to exit the virtual face-to-face communication is acquired (Yes in S508), the controller 113 terminates the processing procedure in FIG. 5A, whereas while not acquiring information corresponding to an operation to suspend or exit (No in S508), the controller 113 executes steps S502 to S506 and transmits, to the server apparatus for the other terminal apparatuses 12, information for displaying a 3D model representing the corresponding user, the drawn image, and information for outputting audio. The determination of the hand image in step S503 may be made during each processing cycle of steps S502 to S506 or may be made at any appropriate timing, such as every few cycles.

FIG. 5B relates to the operating procedures of the controller 113 when the terminal apparatus 12 outputs the image of the 3D model, the hand image, the drawn image, and the audio of the other user. Upon receiving, via the server apparatus 10, a packet transmitted by the other terminal apparatus 12 performing the procedures in FIG. 5A, the controller 113 performs steps S510 to S513.

In step S510, the controller 113 decodes the encoded information included in the packet received from the other terminal apparatus 12 to acquire the captured image, distance image, hand image, drawn image, and audio information.

In step S511, the controller 113 sets the hand image when displaying the 3D model of the other user. The controller 113 sets the hand image transmitted by the other terminal apparatus 12 as the image to be displayed.

In step S512, the controller 113 generates a 3D model representing the corresponding user of the other terminal apparatus 12 based on the captured image and the distance image. In the case of receiving information from a plurality of other terminal apparatuses 12, the controller 113 executes steps S510 to S512 for each of the other terminal apparatuses 12 to generate the 3D model of each corresponding user.

In step S513, the controller 113 places the 3D model representing the other user in the virtual space. The memory 112 stores, in advance, information on the coordinates of the virtual space and the coordinates at which the 3D models should be placed according to the order in which each other user is authenticated, for example. The controller 113 places the generated 3D model at the coordinates in the virtual space.

In step S514, the controller 113 generates an image for display. The controller 113 generates a rendered image, captured from a virtual viewpoint, of the 3D model placed in the virtual space.

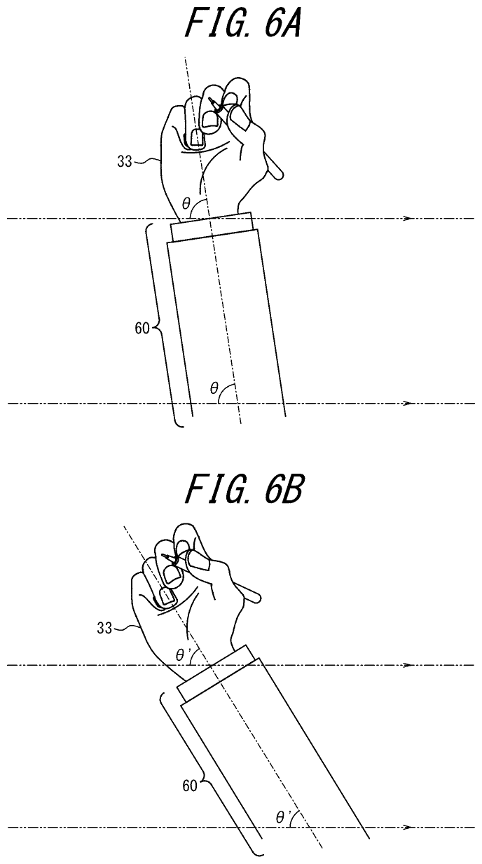

In step S516, the controller 113 displays the image for display, the hand image, and the drawn image, while also outputting audio, via the input/output interface 115. The controller 113 displays the image for display on the display 22 and displays the hand image and the drawn image on the transparent touch panel 21. At this time, the controller makes the display position of the hand image correspond to the position of the hand in the 3D model included in the image for display. The controller 113 also rotates the angle of the hand image to match the angle of the forearm in the 3D model. For example, as illustrated in FIG. 6A, the controller 113 causes the angle θ of the tilt of the hand image 33 relative to the horizontal direction to match with the angle θ of the forearm 60 relative to the horizontal direction in the 3D model. As illustrated in FIG. 6B, in a case in which the angle θ of the tilt of the forearm 60 changes to a different angle θ′ due to movement by the other user, the controller 113 rotates the hand image 33 so that the tilt of the hand image 33 relative to the horizontal direction becomes the angle θ′. This enables the corresponding user to visually recognize a more natural 3D model and hand image.

By the controller 113 repeatedly executing steps S510 to S516, the corresponding user can listen to the speech of another user while watching a video that includes the 3D model of the other user and the drawn image that is drawn by the 3D model. The setting of the hand image in step S511 may be made during each processing cycle of steps S510 to S516 or may be made at any appropriate timing, such as every few cycles.

In a variation, instead of the hand image being determined in step S503 of FIG. 5A, the hand image is determined and set in step S511 of FIG. 5B. For example, the controller 113 acquires the attributes of the other user estimated in step S503 on the other terminal apparatus 12, and in step S512, the controller 113 determines the hand image by extracting a hand image that matches the attributes of the other user from among the hand images stored in the memory 112 in advance. The controller 113 can then set the determined hand image.

As described above, according to the present disclosure, the realistic feel of communication using a transparent touch panel can be enhanced.

In the above example, the terminal apparatus 12 receives information for generating a 3D model of the other user, i.e., the captured image, the distance image, and the like, from the other terminal apparatus 12 before generating the 3D model and generating a rendered image of the 3D model placed in the virtual space. However, processes such as generation of the 3D model and generation of the rendered image may be distributed among the terminal apparatuses 12 as appropriate. For example, a 3D model of the other user may be generated by the other terminal apparatus 12 based on the captured image and the like, and the terminal apparatus 12 that receives the information on the 3D model may generate the rendered image using that 3D model.

In the example above, a case in which the model image is a 3D model has been described. However, the model image may be a 2D model. A three-dimensional structure, in which a 2D model of the other user is displayed on the display and the hand image of the other user is displayed on the transparent touch panel in front of the display, enables an expression of depth with a relatively simple configuration.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A terminal apparatus comprising:
a communication interface;
a transparent panel configured to display an image and accept a drawing;
a display superimposed on the transparent panel;
an imager disposed near the display and configured to capture an image of a user; and
a controller configured to communicate using the communication interface, wherein
the controller is configured to receive, from another terminal apparatus, information for displaying a model image representing another user who uses the another terminal apparatus based on a captured image of the another user, and information on a drawn image that is drawn by the another user using a drawing tool on a transparent panel of the another terminal apparatus, and to display the model image on the display of the terminal apparatus and a hand image of a hand of the another user holding the drawing tool and the drawn image on the transparent panel of the terminal apparatus.

2. The terminal apparatus according to claim 1, wherein the controller is configured to make the hand image correspond to an angle of an arm in the model image.

3. The terminal apparatus according to claim 1, wherein the controller is configured to use the hand image corresponding to a dominant hand of the another user in the model image.

4. The terminal apparatus according to claim 1, wherein the controller is configured to use the hand image corresponding to an attribute of the another user in the model image.

5. The terminal apparatus according to claim 1, wherein the controller is configured to receive the hand image extracted from the captured image from the another terminal apparatus and to use the received hand image.
